(19) United States
(12) Patent Application Publication
(10) Pub. No.: US 2009/0246083 A1
(43) Pub. Date: Oct. 1, 2009

(54) TIMING BASED METHOD AND APPARATUS FOR MONITORING DRINKING WATER PURITY AND ENCOURAGING ROUTINE TESTING OF DRINKING WATER PURITY

(75) Inventors: Robert Samborn, Santa Monica, CA (US); Charles F. Lee, Venice, CA (US); Jin H. Lee, Los Angeles, CA (US); Yun-Ho Son, Seoul (KR)

Correspondence Address: PATENT VENTURE GROUP, 10788 CIVIC CENTER DRIVE, SUITE 215, RANCHO CUCAMONGA, CA, 91730, US

(73) Assignee: HM DIGITAL, INC., Culver City, CA (US)

(21) Appl. No.: 12/055,198

(22) Filed: Mar. 25, 2008

(51) Int. Cl. G01N 27/00; G04F 10/00

(52) U.S. Cl. 422/82.02; 368/109; 368/10

(57) ABSTRACT

An invention is provided for encouraging routine testing for TDS levels in a liquid. The invention includes a conductivity sensor capable of sensing a conductivity level of a liquid, and a processor in electrical communication with the conductivity sensor. The processor has logic that calculates a TDS level for the liquid based on the conductivity level of the liquid. The calculated TDS level for the liquid is then displayed on a display in electrical communication with the processor. Also included is a speaker, which is electrical communication with the processor. To provide automatic reminders to the user, an integrated timing mechanism is included that is in communication with the processor. When a predetermined period of time has elapsed, such as the period of time between periodic TDS level testing, the integrated timing mechanism sends a signal to the processor to provide an alert to the user to test the TDS level.

### CROSS REFERENCE TO RELATED APPLICATIONS

This application is related to U.S. patent application having Ser. No. _______ (Attorney Docket No. HMDIP001), filed on Mar. 25, 2008, and entitled “Method and Apparatus for Routine Liquid Testing for Total Dissolved Solids,” which is hereby incorporated by reference.

### BACKGROUND OF THE INVENTION

1. Field of the Invention

This invention relates generally to liquid testing, including, but not limited to, water quality testing, and more particularly to testing for total dissolved solids (TDS) utilizing a portable TDS meter having properties that stimulate and encourage routine testing.

2. Description of the Related Art

When supplying or utilizing water for human consumption, water generally is maintained at a particular level of purity in order to ensure safe drinking water for humans and animals. In addition, alternate levels of water purity must be maintained for plants, fish, pipes and many industrial, pharmaceutical and medical applications. One means for measuring the purity of an aqueous substance, such as drinking water, is a measure of the total dissolved solids (TDS) in the liquid. TDS is a measure of the total amount of mobile charged ions, such as minerals, salts, and metals dissolved in a liquid, and often is expressed as parts per million (ppm). The lower the TDS level in water, the purer that water is. For example, water with a TDS level of 0 ppm is pure H₂O. Lower levels of TDS in drinking water allow cells to hydrate more efficiently when consumed by the human body. Conversely, high levels of TDS in drinking water increase the probability of harmful contaminants that may increase health risks or hinder absorption of water molecules on a cellular level. TDS also will directly affect the taste of water, generally making it unpleasant to the average person.

In response to the increased risks presented by high TDS levels in water for human consumption, TDS meters have been developed that provide a means to measure the TDS level of a liquid. In general, two principal methods have been utilized in TDS meters to measure the TDS level of a liquid: gravimetric methods and electrical conductivity methods. Gravimetric methods evaporate the liquid solvent leaving a residue that is weighed. Although generally very accurate, gravimetric methods can have problems when large proportions of the TDS consists of organic chemicals having a low boiling point that can evaporate along with the water. Additionally, gravimeters are cumbersome and cost prohibitive for the average, non-scientific user.

Since electrical conductivity of water is directly related to the concentration of dissolved ionized solids in the water, the electrical conductivity method often is utilized by TDS meters. Ions from dissolved solids in the water create the ability for water to conduct electric current. Hence, this electric current can be measured using a conductivity meter. Since pure H₂O has a conductivity of zero, the TDS level of a liquid can be calculated by converting the electrical conductivity using a particular factor into a TDS reading, generally in ppm. A TDS meter utilizing the electrical conductivity method provides a low-cost, easy-to-use mechanism for measuring overall water quality.

In use, an electrical conductivity-based TDS meter first is inserted into the liquid to be tested. The meter then samples the electrical conductivity of the liquid, generally utilizing an electrical conductivity sensor. Thereafter, the electrical conductivity of the liquid is converted to a TDS reading, generally in ppm. Once the TDS level of the liquid is known, the liquid may be subsequently utilized, or appropriate measures may be taken to correct the TDS level, most commonly reduced with a water purifier or filter for drinking water for human consumption. In certain circumstances, such as for plants or fish, the TDS level may need to be increased to accommodate the species' needs.

Typically, a substance must be routinely tested to ensure the proper level of TDS in the liquid is maintained. For example, when monitoring drinking water, the drinking water from a particular source should be routinely tested to ensure proper levels of TDS in the water are maintained. Unfortunately, most consumers do not routinely test their drinking water for TDS levels.

For example, when monitoring tap water, a consumer may obtain a TDS meter and test the TDS level of the tap water. At this point, a decision is generally made whether to correct the TDS level using a water purifier or filter, or to continue drinking the tap water. However, once the consumer has tested the TDS level of tap water, the consumer generally stores the TDS meter out of sight. The out of sight storage of the TDS meter then leads to the consumer forgetting to continue testing the water source or the filtration system that has since been installed. Because the TDS meter is not readily available, the consumer generally does not take the time to retrieve the TDS meter and perform future water tests. In general, every type of water purification or filtration system requires routine maintenance and filter replacement, and the TDS levels of tap water fluctuates daily with precipitation, weather and pipe conditions. Often, as mentioned above, the consumer forgets to test the water source because the TDS meter is stored out of sight. Consequently, if a filter or other means of maintaining low TDS levels in the liquid is applied, over time the TDS level of the product water generally increases due to a decrease in the effectiveness of the filtration system. As a result, the high levels of TDS in the drinking water increase the probability of harmful contaminants that may affect taste, increase health risks, or hinder absorption of water molecules on a cellular level.

In view of the foregoing, there is a need for methods and apparatuses that encourage routine testing of liquids. The methods and apparatuses should encourage routine testing without being overly burdensome for the user. In addition, methods and apparatuses should provide this encouragement without undue increased costs in the manufacture of the TDS meter.

### SUMMARY OF THE INVENTION

Broadly speaking, embodiments of the present invention address these needs by providing a portable total dissolved solids (TDS) meter having properties that encourage and stimulate routine monitoring and testing by the user. These properties provide automatic reminders to the user to perform TDS level tests. For example, in one embodiment, an apparatus for encouraging routine testing for total dissolved solids in liquids is disclosed. The apparatus includes a conductivity sensor capable of sensing a conductivity level of a liquid, and a processor in electrical communication with the conductivity sensor. The processor has logic that calculates a TDS level for the liquid based on the conductivity level of the liquid. The calculated TDS level for the liquid is then displayed on a display in electrical communication with the processor. Also included is a speaker, which is electrical communication with the processor. To provide automatic reminders to the user, an integrated timing mechanism is included that is in communication with the processor. When a predetermined period of time has elapsed, such as the period of time between periodic TDS level testing, the integrated timing mechanism sends a signal to the processor to provide an alert to the user to test the TDS level. For example, the alert can be an audible alert facilitated by the speaker, and/or a visual alert facilitated by the display. In addition, to facilitate storage in a viewable area, an integrated attachment apparatus capable of removably attaching the apparatus to a surface can be included. For example, the attachment mechanism can be a magnet capable of removably attaching the apparatus to a metallic surface, such as a refrigerator or water filtration system.

In an additional embodiment, a method for encouraging routine testing for TDS levels in a liquid is disclosed. The method includes counting an elapsed time using an integrated timing mechanism in a TDS testing apparatus. Then, an alert indicating a TDS test should be performed is provided when a predetermined period of time has been counted. In general, a programmable value for the predetermined period of time can be stored in the memory of the TDS testing apparatus. When the value is reached, the predetermined period of time has been counted and the alert, which can be an audible alert, a visual alert, or both is provided, generally utilizing an integrated speaker, display, or both.

A TDS meter for determining total dissolved solids in liquids is disclosed in a further embodiment of the present invention. The TDS meter includes a housing having a length in the range of about four inches to twelve inches and a width in the range of about one half inch to two inches. Disposed at least partially within the housing is a conductivity sensor that is capable of sensing a conductivity level of a liquid. Also disposed within the housing and in electrical communication with the conductivity sensor is a processor that includes logic that calculates a TDS level for the liquid based on the conductivity level of the liquid. In addition, a display is included that is in electrical communication with the processor and is capable of displaying the calculated TDS level for the liquid. Further, a speaker is included as is an integrated timing mechanism, which is in communication with the processor. Similar to above, in operation the integrated timing mechanism sends a signal to the processor to provide an alert when a predetermined period of time has elapsed. To facilitate automatic reminders, the integrated timing mechanism can be automatically reset when the TDS meter is set to a power ON state after the predetermined period of time has elapsed.

In this manner, embodiments of the present invention advantageously provide an automatic reminder to the user to perform TDS testing at predetermined time intervals. Moreover, since the integrated timing mechanism is automatically reset whenever the TDS meter is powered ON after the predetermined period of time has elapsed, the user is not required to continue setting testing reminders, which could lead to further non-testing due to user forgetfulness to set a reminder. In addition, by providing an attachment mechanism capable of attaching the apparatus to a visible surface, embodiments of the present invention provide a constant reminder to the user to test TDS levels. Moreover, the user also avoids the need to search for the TDS apparatus and retrieve the apparatus from an inconvenient storage location. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a block diagram showing major components of a portable apparatus for determining total dissolved solids (TDS) in a liquid and encouraging routine use, in accordance with an embodiment of the present invention;

FIG. 2 is a diagram illustrating an exemplary arrangement of components in a front area and a back area of the apparatus, in accordance with an embodiment of the present invention;

FIG. 3 is a block diagram showing a functional flow of the apparatus for testing TDS levels, in accordance with an embodiment of the present invention;

FIG. 4 is a flowchart showing a method for encouraging routine testing of liquid TDS levels in a home or office water system, in accordance with an embodiment of the present invention; and

FIG. 5 is a flowchart showing a method for providing TDS testing alerts to a user, in accordance with an embodiment of the present invention.

### DETAILED DESCRIPTION OF THE PREFERRED EMBODIMENTS

An invention is disclosed for encouraging the use of a total dissolved solids (TDS) meter for testing liquid purity. Broadly speaking, embodiments of the present invention provide this functionality by affording a portable TDS meter having properties that encourage and stimulate routine testing by the user. In one embodiment, the portable TDS meter includes functionality that enables automatic alerts or reminders as to when to perform TDS tests. In general, these reminders are performed automatically, that is, without the need for a user to consciously setup a reminder each time the meter is stored. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

As mentioned previously, when an average consumer utilizes a TDS meter to test the TDS levels of a liquid, the test generally is only performed once. This is because the average user is not reminded of the need for continued testing of the liquid for TDS levels. However, it is encouraged by professionals in the water quality industry that TDS testing be done on a weekly basis. Embodiments of the present invention address this issue by providing an apparatus for TDS testing that provides a reminder to the user to continue testing liquids for TDS levels. In one embodiment, this reminder is provided by a mechanism that provides automatic reminders to the user as to when to perform TDS tests. These reminders can be audible, visual, or both. Moreover, once initially setup, the reminders will occur automatically, without the need for the user to constantly set reminders each time the portable TDS meter is powered OFF.

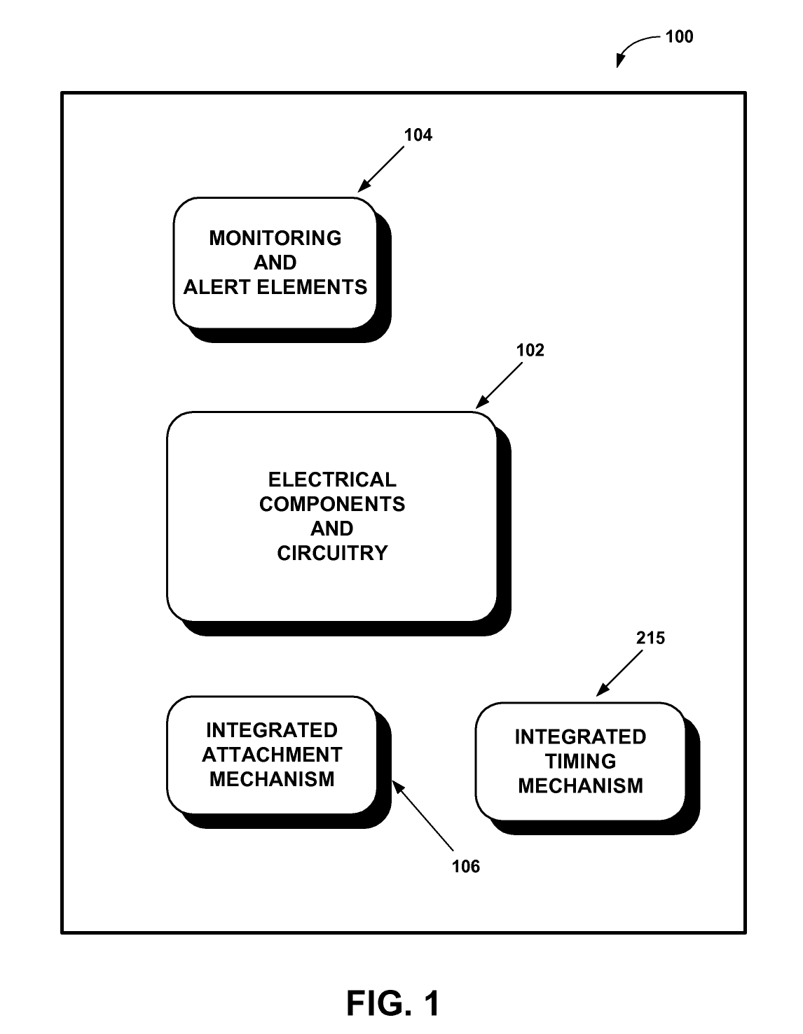

FIG. 1 is a block diagram showing major components of a portable apparatus 100 for determining total dissolved solids (TDS) in a liquid and encouraging routine use, in accordance with an embodiment of the present invention. The apparatus 100 includes electrical components and circuitry 102, monitoring and alert elements 104, an attachment mechanism 106, and an integrated timing mechanism 215. The electrical components and circuitry 102 of the apparatus 100 are utilized to determine the TDS level of a liquid such as water utilizing a determination of the conductivity of the liquid. As will be described in greater detail subsequently, the monitoring and alert elements 104 are utilized to display the TDS level determination to a user and to alert the user to testing times for TDS testing. The integrated attachment mechanism 106 provides in sight storage that allows the apparatus to be removably attached to a vertical metallic surface, such as a refrigerator, as described in co-pending U.S. application Ser. No. ______ (Attorney Docket No. HMDIP001), entitled “Method and Apparatus for Routine Liquid Testing for Total Dissolved Solids,” filed Mar. 25, 2008, which is incorporated herein by reference in its entirety. The integrated timing mechanism 215 facilitates counting of elapsed time to determine when to alert the user to perform a TDS level test, as will be described in greater detail below.

The apparatus 100 determines the TDS of a liquid by measuring the electrical conductivity of a liquid, such as water. In general, embodiments of the present invention estimate the TDS Level based on the conductivity level of the liquid. That is, once the conductivity level of the liquid is determined, the electrical components and circuitry 102 determine the TDS Level by converting the measured conductivity into a TDS Reading which is displayed by the monitoring and alert elements 104. To increase accuracy in determining the TDS level from the conductivity level, one embodiment of the present invention accounts for different liquid mediums by utilizing different conversion factors based on the liquid medium being tested.

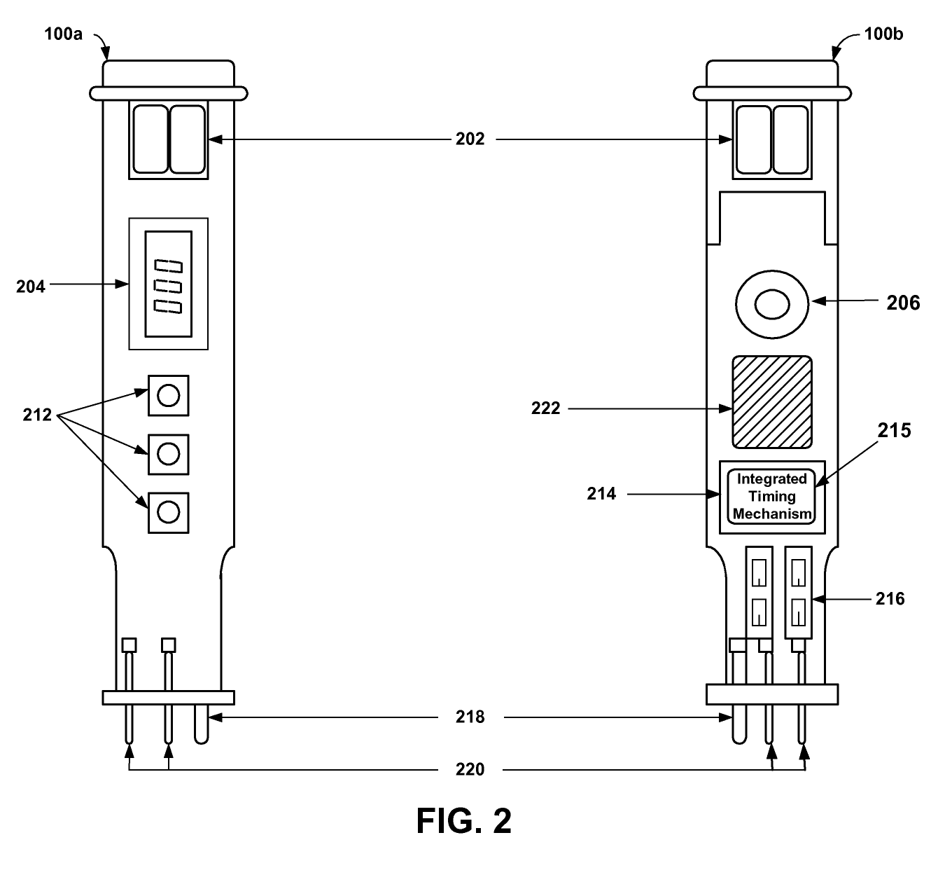

FIG. 2 is a diagram illustrating an exemplary arrangement of components in a front area 100a and a back area 100b of the apparatus, in accordance with an embodiment of the present invention. As illustrated in FIG. 2, disposed in the front area 100a of the exemplary arrangement are batteries 202, a liquid crystal display (LCD) display 204, user controls 212, a thermistor 218, and the conductivity sensor pins 220 of the conductivity sensor. Disposed in the back area 100b of the exemplary arrangement are the batteries 202 (which are also visible from the front area 100a), a speaker 206, an integrated attachment mechanism 222, a processor 214 including an integrated timing mechanism 215, conductivity circuitry 216, and the thermistor 218 and sensor pints 220 (which are also visible from the front area 100a).

In general, the above components can be disposed on a circuit board to provide necessary electrical connections. Power for the apparatus can be provided by way of a DC voltage power source in the form of two Silver Oxide or Lithium batteries 202, which provide power to all electrical components disposed on the circuit board. The LCD display 204 provides a visual means to view pertinent information generated by the processor 214, such as calculated TDS level readings and helpful alert messages. The speaker 206 provides a mechanism for providing audible alerts to a user, such as audible indications that the apparatus has been powered on, powered off, indications of when a TDS test should be performed, and other audible alerts. The user controls 212, for example micro switches, provide a means for users to enter commands and data into the apparatus, such as power on and off commands, data hold commands, temperature readings, changing modes, programming, checking temperature, performing digital calibration, and other processor directives as will be apparent to those skilled in the art after a careful reading of the present disclosure.

Because the conductivity of a liquid is affected by temperature, the apparatus includes a thermistor 218. The thermistor 218 serves to calibrate the apparatus based on the temperature of the liquid in which the apparatus is inserted. Broadly speaking, the thermistor 218 is a resistor having a resistance that varies with the temperature of the liquid in which it is submerged. In this manner, the thermistor 218 provides a mechanism to determine a temperature compensator coefficient to the processor 214 for TDS level calculation. The sensor pins 220, used in conjunction with the thermistor 218, provide a mechanism to determine the conductivity of the liquid in which they are submerged. In one embodiment, the sensor pins 220 are constructed from a lower resistance material such as copper, aluminum, graphite, or platinum, which provides a low resistance to the flow of electric current and serves as a carrier for the electric current when submerged in a test sample of a liquid.

In one embodiment, the components of the apparatus are disposed in a housing that encloses the batteries 202, speaker 206, processor 214, conductivity circuitry 216, and attachment mechanism 222, while partially enclosing the thermistor 218 and conductivity sensor pins 220 of the conductivity sensor. The LCD display 204 and user controls 212 can be provided on the outside of the housing allowing viewing and manipulative access to the user. Preferably, the apparatus 100 has a length in the range of about four inches to twelve inches and a width in the range of about one half inch to two inches, whereby the apparatus is portable. In this manner, the apparatus 100 can be easily handled by the user and stored in a convenient location, such as attached to the surface of the refrigerator utilizing the attachment mechanism.

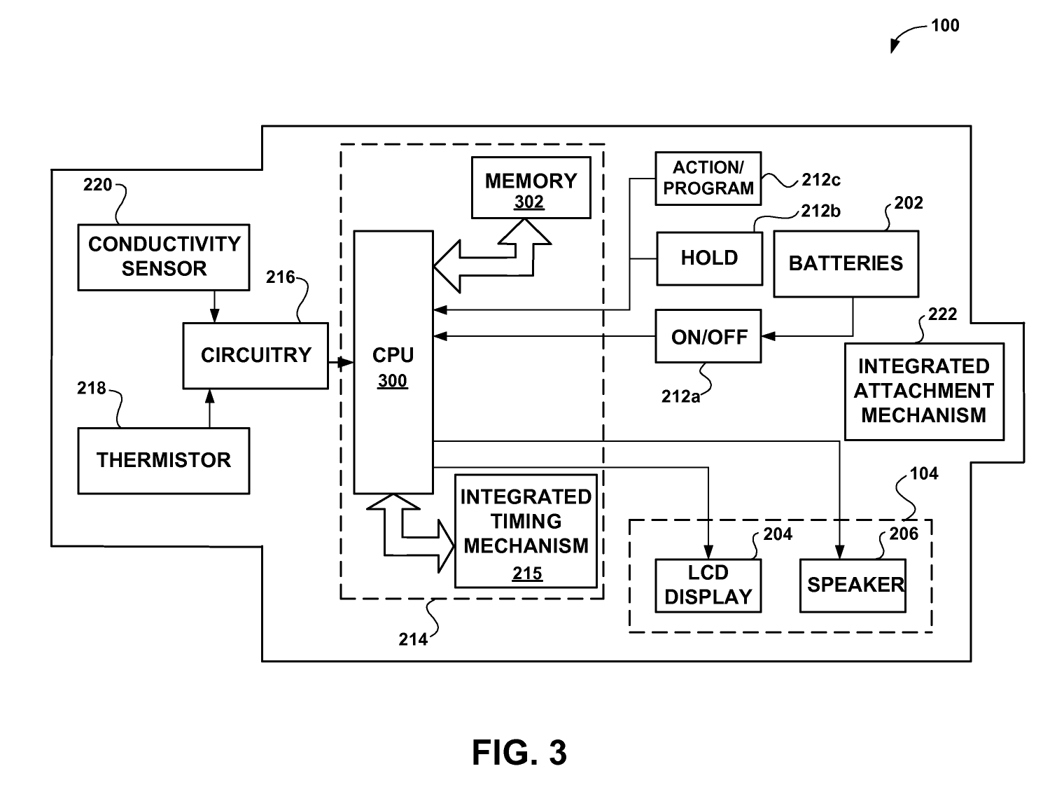

FIG. 3 is a block diagram showing a functional flow of the apparatus 100 for testing TDS levels, in accordance with an embodiment of the present invention. As shown in FIG. 3, the apparatus 100 includes a conductivity sensor 220 and thermistor 218 in communication with the processor 214 via circuitry 216. The processor 214 can include, for example, a CPU 300 in electrical communication with a memory 302 and an integrated timing mechanism 215. The processor 214 further is in electrical communication with user controls, such as an on/off control 212a, a hold control 212b, and an action/program control 212c. The on/off user control 212a also controls current from the batteries 202 to the remainder of the apparatus components. In addition, the processor 214 is in communication with the LCD display 204 and speaker 206. Further, an integrated attachment mechanism 222 can be included that allows the apparatus to be removably attached to a vertical metallic surface, such as a refrigerator.

In operation, an end of the apparatus 100 is inserted into a sample of a liquid to be tested. More specifically, the apparatus 100 is inserted into the sample such that the conductivity sensor 220 (i.e., the senor pins) and the thermistor 218 are submerged in the liquid sample. The submerged sensor pins of the conductivity sensor 220 sense the degree of electrical conductivity present in the liquid or water. To some degree, most elements other than hydrogen and oxygen conduct electricity. Thus, the conductivity of the liquid can be utilized to determine the TDS level of the liquid. A signal from the conductivity sensor 220 and the thermistor 218 is provided to the CPU 300 of the processor 214 via circuitry 216, generally comprising discrete components on a circuit board. Once the signal is received, the CPU 300 calculates a TDS reading based on the signals from the conductivity sensor 220 and the thermistor 218. The calculated TDS reading then is displayed on the LCD display 204. As mentioned above, the CPU 300 of the processor 214 utilizes the signal from the thermistor 218 to calibrate the calculated TDS reading based on the temperature of the liquid. As noted previously, embodiments of the present invention encourage and stimulate routine testing by the user by including functionality that enables automatic alerts or reminders as to when to perform TDS tests utilizing the integrated timing mechanism 215, speaker 206, and LCD display 204. In general, these reminders are performed automatically, that is, without the need for a user to consciously setup a reminder each time the meter is stored.

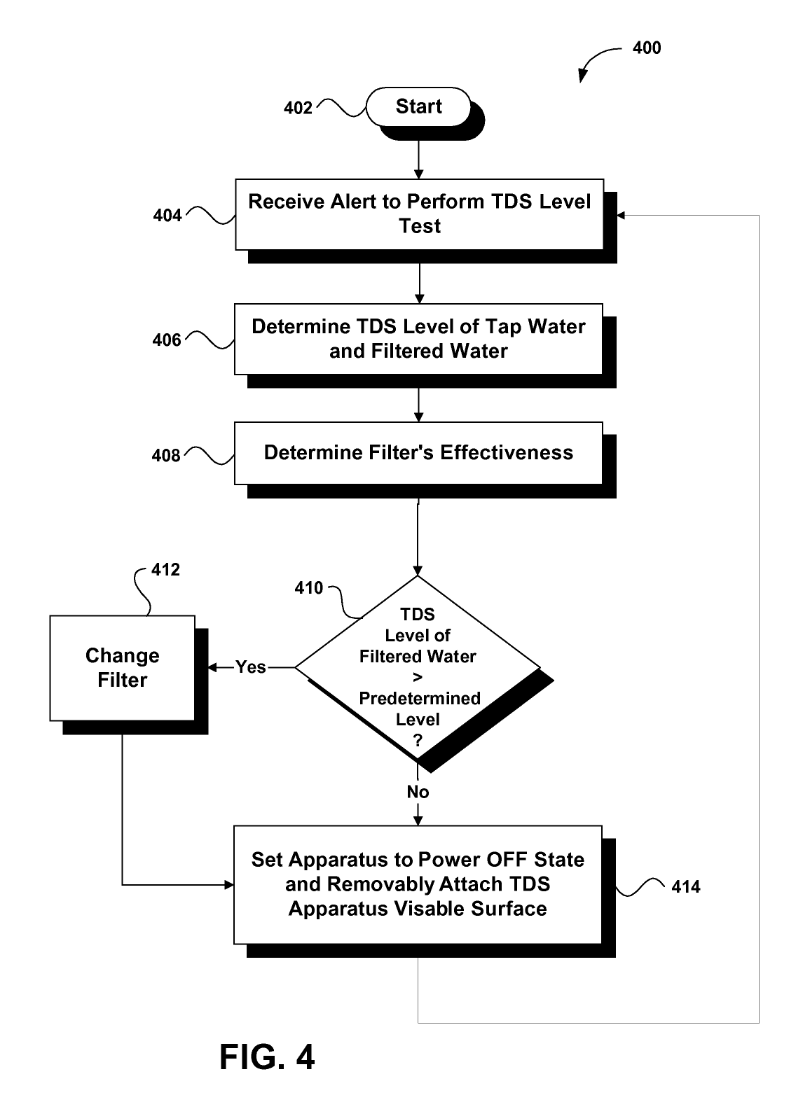

FIG. 4 is a flowchart showing a method 400 for encouraging routine testing of liquid TDS levels in a home or office water system, in accordance with an embodiment of the present invention. Specifically, method 400 illustrates a process for determining when a filter in a water filtration system should be changed to maintain a particular level of water purity utilizing an apparatus in accordance with an embodiment of the present invention. Although the following discussion of method 400 will be described in terms of water filtration, it should be noted that the apparatus 100 for TDS level testing of the embodiments of the present invention can be utilized for TDS testing in any environment, such as general water study, filter design, and other applications that will be apparent to those skilled in the art after a careful reading of the present disclosure.

In an initial operation 402, preprocess operations are performed. Preprocess operations can include, for example, determining a maximum TDS level desired for the liquid being tested, determining and installing proper filters when used in conjunction with a water filtration system, and other preprocess operations that will be apparent to those skilled in the art after a careful reading of the present disclosure.

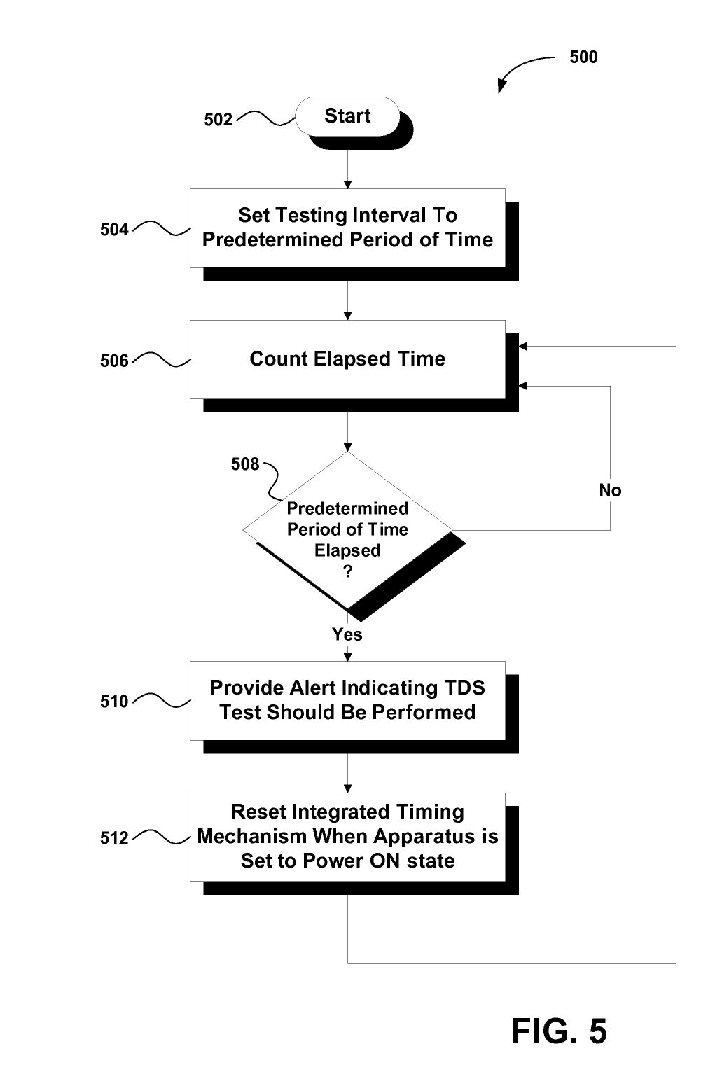

In operation 404, an alert is received to perform a TDS test. When an average consumer utilizes a TDS meter to test the TDS levels of a liquid, the test generally is only performed once. This is because the average user is not reminded of the need for continued testing of the liquid for TDS levels. Embodiments of the present invention address this issue by providing an apparatus for TDS testing that provides a reminder to the user to continue testing liquids for TDS levels. In one embodiment, this reminder is provided by a mechanism that provides automatic reminders to the user to perform TDS tests. These reminders can be audible, visual, or both. Moreover, once initially setup, the reminders will occur automatically, without the need for the user to constantly set reminders each time the portable TDS meter is powered OFF, as described next with respect to FIG. 5.

FIG. 5 is a flowchart showing a method 500 for providing TDS testing alerts to a user, in accordance with an embodiment of the present invention. In an initial operation, preprocess operations are performed. Preprocess operations can include, for example, determining a desired timing interval between TDS testing, determining a maximum TDS level desired for the liquid being tested, and other preprocess operations that will be apparent to those skilled in the art after a careful reading of the present disclosure.

In operation 504, the integrated timing mechanism is set to count a predetermined period of time between TDS testing. Referring to FIG. 2, a user can utilize the user controls 212 to set a predetermined period of time that will be utilized in determining when to alert the user that TDS testing should be performed. In general, as the user inputs data, the data is displayed on the LCD display 204 for user confirmation. Typically, the predetermined period of time is input as a number, which can be increased on decreased utilizing the user controls 212, that indicates, months, days, hours, minutes, and/or seconds that define the predetermined period of time. Once the data is entered, the user controls 212 can be utilized to indicate that the current value should be stored into memory 302 (illustrated in FIG. 3).

Referring back to FIG. 5, the user generally is only required to set the predetermined period of time once, upon initial use. However, it should be noted that the predetermined period of time can be reset or changed at anytime, as needed. In addition, it should further be noted that the predetermined period of time can be set and stored during manufacturing or initialization of the hardware forming the TDS testing apparatus 100. As such, a user may not be required to set the predetermined period of time for the TDS testing apparatus 100, as the predetermined period of time may already be set and initialized.

Once the predetermined period of the time has been set, either by the user or during manufacturing/product initialization, the elapsed time is counted, in operation 506. In general, embodiments of the present invention begin counting elapsed time once the integrated timing mechanism has been set or reset.

Then, in operation 508, a decision is made as to whether the predetermined period of time has elapsed. As the integrated timing mechanism 215 continues to count elapsed time, a check is made as to whether the predetermined period of time has elapsed. If the predetermined period of time has not elapsed, the method 500 repeats to operation 506 where elapsed time continues to be counted. However, if the predetermined period of time has elapsed, the method 500 continues to operation 510.

In operation 510, an alert indicating a TDS test should be performed is executed. Turning to FIG. 3, as the integrated timing mechanism 215 counts elapsed time, the CPU 300 checks the elapsed time counted to determine whether the predetermined period of time value stored in memory 302 has elapsed. When the predetermined period of time value stored in memory 302 has elapsed the CPU 300 provides signals necessary to provide an alert to the user. In one embodiment, the alert is both an audible alert and a visual alert, however, it should be noted that embodiments of the present invention do not required both an audible alert and a visual alert. That is, embodiments can provide only and audible alert or only a visual alert. In addition, embodiments of the present invention can be configured to allow the user to select which alerts the apparatus 100 should provide (i.e., audible, visual, or both). When an audible alert is provided, the CPU 300 provides a signal to the speaker 206 to provide an audible signal indicating that a TDS test should be performed. Similarly, when a visual alert is provided, the CPU 300 provides a signal to the LCD display 204 to provide a visual signal indicating that a TDS test should be performed. Visuals can include, for example, blinking text, blinking background, a predetermined visual animation, or other visual signal that indicates to the user that a TDS test should be performed.

Referring back to FIG. 5, once the alert (visual, audible, or both) has been provided, the user, now alerted to the need for a TDS test, will utilize the TDS apparatus 100 to perform a TDS test. Upon being powered ON, the integrated timing mechanism 215 is reset in operation 512. It should be noted that the user is not required to immediately act on the alert because the alert signal generally will be continued until the TDS meter is powered ON. Because the user generally is required to power the TDS meter ON prior to utilizing the TDS meter to perform a TDS test, the power ON signal can be utilized as an indication that a TDS test has been performed and a new count until the next TDS should be performed. Thus, when the TDS meter is powered ON following the execution of the audible or visual alert, the integrated timing mechanism 215 is reset and the method 500 continues with another elapsed time count in operation 506. Hence, the TDS meter of the embodiments of the present invention advantageously provides an automatic reminder to the user to perform TDS testing a predetermined time intervals. Moreover, since the integrated timing mechanism is automatically reset whenever the TDS meter is powered ON following the execution of an audible or visual alert, the user is not required to continue setting testing reminders, which could lead to further non-testing due to user forgetfulness to set a reminder.

Referring back to FIG. 4, once the alert to perform a TDS level test is received, the TDS meter is powered ON, the integrated timing mechanism is reset, and the TDS level of the tap water and the filter water is determined in operation 406. As indicated above, the integrated timing mechanism is reset when the TDS meter is powered ON following the execution of an alert as an indication that a TDS test has or will be performed. Once powered ON, embodiments of the present invention can be utilized to determine when the useful life of a filter is over and the filter should be changed. By analyzing the TDS level of water before and after the water has been filtered, embodiments of the present invention can determine when the filter is no longer filtering a desired level of TDS from the liquid, and thus when the life of the filter is over. Thus, in operation 406, the TDS level of the tap water and the filter water is determined by inserting the TDS apparatus 100 into a sample of the filtered water and unfiltered tap water.

For example, the apparatus 100 can be inserted into a sample of the filtered water such that the conductivity sensor 220 (i.e., the senor pins) and the thermistor 218 are submerged in the sample. The submerged sensor pins of the conductivity sensor 220 sense the degree of electrical conductivity present in the liquid or water, and signals from both the conductivity sensor 220 and the thermistor 218 are provided to the processor 214. Once the signals are received, the processor 214 calculates a TDS reading based on the signals from the conductivity sensor 220 and the thermistor 218. The calculated TDS reading then is displayed on the LCD display 204. The apparatus 100 can then be removed from the sample of filtered and inserted into a sample of the unfiltered tap water and the above testing process repeated to determine the TDS level of the unfiltered tap water.

Once the TDS level of both the unfiltered tap water and filtered water is determined, the effectiveness of the filter can be determined in operation 408. Although optional, operation 408 allows the effectiveness of the filter to be determined based on the difference between TDS levels of the liquid before and after filtering. In this manner a user can compare filter effectiveness of different filters.

A decision is then made as to whether the TDS level of the filtered water is greater than a predetermined level, in operation 410. As discussed above, a maximum desired TDS level for the liquid being tested is determined. The maximum desired TDS level then becomes the predetermined level of the method 400. If the TDS level of the filtered water is greater than a predetermined level, the method 400 branches to operation 412. Otherwise, the method 400 continues to operation 414.

When the TDS level of the filtered water is greater than a predetermined level the filter is no longer filtering the water as desired. Thus, in operation 412, the current filter is removed from the water filtration system and a new filter is installed. In this manner, the life of a filter can be extended or bad filters can be spotted early. In general, filter manufactures estimate the useful life of a filter in terms of a particular period of time the filter can be utilized. However, the estimated useful life is rarely correct. For example, when not in constant use, a filter's useful life may be much longer than a manufacture's estimate. Conversely, if used more than estimated, the filter's useful life may be much shorter than the manufacture's estimate. Thus, embodiments of the present invention can be utilized to more accurately determine when a filter is no longer performing as desired and should be changed.

Once testing is completed, the TDS apparatus 100 is powered OFF. As indicated above, the integrated timing mechanism is reset when the apparatus is powered ON following the execution of an alert and begins to count elapsed time. Hence, the predetermined period of time value stored in memory will begin to be counted once the integrated timing mechanism is reset. In addition, the TDS apparatus can be attached to a refrigerator or water filtration system in constant sight when in the room utilizing the integrated attachment mechanism 222 as a constant reminder to test the TDS level of the liquid. Hence, in addition to encouraging routine testing via the integrated timing mechanism and alert system described above, embodiments of the present invention can encourage and stimulate routine testing by providing in sight storage via the integrated attachment mechanism 222. In this manner, the apparatus 100 can be stored within sight of the user, discouraging concealed storage of the apparatus that can lead to non-testing due to forgetfulness of the user.

In one embodiment, the attachment mechanism 222 is a magnet designed to fit within the housing that encloses the processor and a portion of the conductivity sensor. The magnet can be designed to have a gauss rating that allows the apparatus to be removably attached to a metallic surface and removed from the metallic surface without damaging the metallic surface. Furthermore the magnet has a gauss rating such that other components of the apparatus are not adversely affected by the magnet.

Once the TDS testing apparatus is powered OFF and attached to a surface, the method 400 continues with another alert operation 404 when the predetermined period of time has elapsed as counted by the integrated timing mechanism, as discussed above with respect to FIG. 5. Hence, the TDS meter of the embodiments of the present invention advantageously provides an automatic reminder to the user to perform TDS testing at predetermined time intervals. In addition, by providing an attachment mechanism capable of attaching the apparatus to a visible surface, embodiments of the present invention provide a constant reminder to the user to test TDS levels. Moreover, the user also avoids the need to search for the TDS apparatus and retrieve the apparatus from an inconvenient storage location.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. An apparatus for determining total dissolved solids in liquids, comprising:
a conductivity sensor capable of sensing a conductivity level of a liquid;
a processor in electrical communication with the conductivity sensor, the processor having logic that calculates a total dissolved solids (TDS) level for the liquid based on the conductivity level of the liquid;
a display in electrical communication with the processor, the display capable of displaying the calculated TDS level for the liquid; and
an integrated timing mechanism in communication with the processor, wherein the integrated timing mechanism sends a signal to the processor to provide an alert when a predetermined period of time has elapsed.

2. An apparatus as recited in claim 1, wherein the integrated timing mechanism is reset when the apparatus is set to a power ON state after the predetermined period of time has elapsed.

3. An apparatus as recited in claim 1, further comprising a speaker in electrical communication with the processor.

4. An apparatus as recited in claim 3, wherein the alert is an audible alert facilitated by the speaker.

5. An apparatus as recited in claim 1, wherein the alert is a visual alert facilitated by the display.

6. An apparatus as recited in claim 1, further comprising an integrated attachment apparatus capable of removably attaching the apparatus to a surface.

7. An apparatus as recited in claim 6, wherein the attachment mechanism is a magnet capable of removably attaching the apparatus to a metallic surface.

8. An apparatus as recited in claim 7, wherein the attachment mechanism is disposed within a housing that encloses the processor and a portion of the conductivity sensor.

9. A method for encouraging routine testing for total dissolved solids (TDS) levels in a liquid, comprising the operations of:
counting an elapsed time using an integrated timing mechanism disposed in a TDS testing apparatus; and
providing an alert indicating a TDS test should be performed when a predetermined period of time has been counted.

10. A method as recited in claim 9, further comprising the operation of storing a value for the predetermined period of time in a memory of the TDS testing apparatus.

11. A method as recited in claim 9, wherein the alert is an audible alert.

12. A method as recited in claim 9, wherein the alert is a visual alert.

13. A method as recited in claim 9, wherein the alert is both a visual alert and an audible alert.

14. A total dissolved solids (TDS) meter for determining total dissolved solids in liquids, comprising:
a housing having a length in the range of about four inches to twelve inches and a width in the range of about one half inch to two inches;
a conductivity sensor disposed at least partially within the housing, the conductivity sensor capable of sensing a conductivity level of a liquid;
a processor disposed within the housing and in electrical communication with the conductivity sensor, the processor having logic that calculates a TDS level for the liquid based on the conductivity level of the liquid;
a display in electrical communication with the processor, the display capable of displaying the calculated TDS level for the liquid;
a speaker in electrical communication with the processor; and
an integrated timing mechanism in communication with the processor, wherein the integrated timing mechanism sends a signal to the processor to provide an alert when a predetermined period of time has elapsed.

15. A TDS meter as recited in claim 14, further comprising an integrated attachment mechanism disposed within the housing, the integrated attachment mechanism capable of removably attaching the apparatus to a surface.

16. A TDS meter as recited in claim 14, wherein the integrated timing mechanism is reset when the TDS meter is set to a power ON state after the predetermined period of time has elapsed.

17. A TDS meter as recited in claim 16, wherein the integrated timing mechanism is configured to begin counting elapsed time when the integrated timing mechanism is reset.

18. A TDS meter as recited in claim 14, wherein the alert is an audible alert facilitated by the speaker.

19. A TDS meter as recited in claim 14, wherein the alert is a visual alert facilitated by the display.
